(19) United States
(12) Patent Application Publication
(10) Pub. No.: US 2015/0156170 A1
(43) Pub. Date: Jun. 4, 2015

(54) Security Event Routing In a Distributed Hash Table

(71) Applicant: Alcatel-Lucent USA Inc., Murray Hill, NJ (US)

(72) Inventor: Vijay Gurbani, Lisle, IL (US)

(73) Assignee: ALCATEL-LUCENT USA INC., Murray Hill, NJ (US)

(21) Appl. No.: 14/094,961

(22) Filed: Dec. 3, 2013

(51) Int. Cl. H04L 29/06

(52) U.S. Cl. CPC H04L 63/0281

(57) ABSTRACT

Embodiments include components of a computer defense network (CND) architecture, e.g. a content addressable network (CAN) gateway, a CAN peer or a CND controller. The gateway is configured to receive from a host a security event log that includes a protocol tag, and to securely forward the log to a selected one of a plurality of CAN peers based on the protocol tag. The CAN peer is configured to configured to filter the events based on an assigned communication protocol, and to produce a security report from the filtered events. The CND controller is configured to receive the filtered report from the peer and to defend the network against a threat based on the report.

### TECHNICAL FIELD

The disclosure relates generally to the field of network communication.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

In current network architectures, security features may be provided as an add-on feature after the network is configured. However, security is much easier to accept when it is part of the networking infrastructure than when it is a standalone requirement. In future networks, applications that have yet to be developed may be provided to network users, and such applications will likely have new and yet unseen security issues.

Among the current information security prevention systems such as firewalls and the Intrusion Detection System (IDS), there exist several deficiencies such as alert overload, high false alarm rate, absence of effective alert management mechanisms, etc. As a result, alert data overload may occur in the network, and these data alert could be redundant, irrelevant or meaningless. A result of this information flooding is sometimes the inability to correctly correlate the events to locate the security breach. Cloud computing exacerbates this situation further as newly instantiated services need to be protected and an unused virtual machine are taken out of service. This dynamicity results in a profile that is complex and not amenable to simple rate alert management systems.

### SUMMARY

One embodiment provides an apparatus, e.g. a content addressable network (CAN) gateway, that includes a processor and a memory coupled to the processor. The memory contains instructions that when executed configure the processor to operate to receive from a security event generator, e.g. a host, a security event log that includes a protocol tag. The processor is further configured to operate to securely forward the log to a selected one of a plurality of peers in a distributed hash table (DHT), based on the protocol tag.

In any embodiment of the apparatus the DHT may be a content addressable network. In any embodiment the processor may be configured to accept the security event log only on the condition that the log includes a valid security certificate. In any embodiment the processor may be configured to forward the log only on the condition that the selected one is authenticated with a receiving entity.

Another embodiment provides an apparatus, e.g. a peer of a distributed hash table (DHT), that includes a processor and a memory coupled to the processor. The memory includes instructions that when executed, e.g. by the processor, configure the processor to operate to receive security event logs from an event generator, e.g. via a gateway node. The processor is further configured to filter the events, and to produce a security report from the filtered events. The processor may then send the report to a security controller.

In any embodiment of the aforementioned apparatus, the processor is further configured to filter events by rejecting events associated with non-assigned communication protocols. In any embodiment the processor may be configured to receive the events from a single gateway computer. In any embodiment the processor may be one of a plurality of processors configured to filter the events, with only the processor being configured to send the report to a security controller.

Another embodiment provides an apparatus, e.g. a computer network defense (CND) controller, that includes a processor and a memory coupled to the processor. The memory includes instructions that when executed configure the processor to operate to receive one of a plurality of security reports from corresponding ones of a plurality of peers in a computer network. Each of the security reports is associated with a particular communication protocol. The instructions further configure the processor to defend, in response to the received security event reports, against a threat to the network based on the received reports.

In any embodiment of the aforementioned apparatus, the peers may be members of a distributed hash table (DHT). In any such embodiment the DHT may include a content addressable network. In any embodiment of the apparatus the processor may be configured to accept the security reports only on the condition that identity of each of the peers is authenticated. In any embodiment the processor may be configured to issue instructions that block traffic from an internet protocol (IP) address associated with the threat.

Another embodiment provides a method, e.g. of operating a CAN gateway. The method includes receiving from an event generator a security event log including a protocol tag. The security event log is securely forwarded to a selected one of a plurality of peers in a distributed hash table (DHT), based on the protocol tag.

In some embodiments of the method the DHT may be a content addressable network. In some embodiments the security event log is accepted only on the condition that the security event log includes a valid security certificate. In some embodiments the security event log is forwarded only on the condition that the selected one is authenticated with a receiving entity.

Another embodiment provides a method, e.g. of operating a peer in a computer network, e.g. a DHT. The method includes receiving security event logs from an event generator, e.g. via a gateway. Logged events are filtered based on an assigned communication protocol, thereby producing a security event report. The event report may be sent to a security controller.

Any embodiment of the aforementioned method may include filtering the events by rejecting events associated with non-assigned communication protocols. In any embodiment the filtering may include determining a statistical measure of the filtered events.

Another embodiment provides a method, e.g. of operating a CND controller. The method includes receiving one of a plurality of security event reports from each of a corresponding plurality of peers in a computer network. Each one of the security event reports is associated with a particular communication protocol. In response to the received security event reports, the method defends against a threat to the network based on the received security event reports. The defending comprises at least one of 1) electronically generating a visual or aural notification, and 2) directing instructions to a router via a physical data path to block internet traffic originating from an IP address associated with the threat.

In any embodiment of the aforementioned method the peers may be members of a distributed hash table (DHT). In any embodiment the DHT may include a content addressable network. In any embodiment the security event reports may be accepted only from ones of the peers that have an authenticated identity. In any embodiment instructions may direct the router to block IP packets from the IP address to a controller of the network.

In any embodiment of the aforementioned apparatuses and methods, the communication protocol may be one of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.

### BRIEF DESCRIPTION OF THE DRAWINGS

A more complete understanding of the present invention may be obtained by reference to the following detailed description when taken in conjunction with the accompanying drawings wherein:

FIG. 1 illustrates a prior art computer network defense system;

FIG. 2 illustrates a cloud computer network defense (CND) architecture in accordance with disclosed embodiments, including hosts, a gateway, peers of a DHT, and a DHT controller;

FIG. 3 illustrates steps for processing events in accordance with disclosed embodiments;

FIG. 4 illustrates steps related to an event arriving at a content addressable network (CAN) in accordance with described embodiments;

FIG. 5 illustrates a torus that may be used to model the mathematical space of the CAN network of FIG. 2; and

FIG. 6 illustrates an example of a CAN message suitable to convey a security event log produced by a host illustrated in FIG. 2.

### DETAILED DESCRIPTION

The disclosure is directed to, e.g. apparatus, systems and methods for defending a computer network from malicious network traffic.

Embodiments presented herein provide, e.g., an improved computer network defense (CND) architecture for responding to security threats directed against computer networks. Event generators, e.g. programs running on computer hosts connected to a network, may detect events related to a security threat, e.g. an attack by a malicious entity. The network may be part of, e.g. a cloud network, enterprise network or internet service provider (ISP) network. The generators may report the events to a gateway computer connected to network servers that may be members of a DHT. The servers may be organized in a virtual space in which each server may filter and/or aggregate security logs received from the gateway computer. The gateway computer may deterministically route the logs according to a protocol tag received with each log, wherein the tag corresponds to a particular communications protocol, e.g. HTTP, SIP, or FTP. Each server may aggregate the event logs received by it and securely forward a security report to a CND controller. The CND controller may analyze the received reports and determine if the network is under attack, and respond accordingly. Because the security reports are based on filtered and/or aggregated security events, computational load on the controller is reduced, reducing the possibility of an attacker overwhelming the ability of the controller to respond effectively to the threat. Furthermore, the security event log and aggregated reports may be transmitted securely within the CND architecture, the architecture is expected to be robust against attempts by an attacker to defeat countermeasures employed by the CND controller.

The CND can be implemented on one of several levels, e.g. on a departmental level, an enterprise level, or Internet Service Provider (ISP) level. When implemented at a very coarse-grain level (i.e. ISP-level), issues such as privacy of information between different cloud customers of the ISP become important, as does the confidentiality of data flowing between the ISP and its customers. Various embodiments address such a need for confidentiality by using an OpenSSL or a GnuTLS library with either self-signed certificates or certificates issued by a certificate authority to perform mutual authentication of the parties and negotiate the cryptographic properties for creating an encryption channel.

Some aspects of this disclosure are related to D. K. Al-Omari, et al., “A Novel Architecture for a Computer Network Defense (CND) System Using Content Addressable Networks (CAN)”, Globecom Workshops (GC Wkshps), 2012 IEEE vol., no., pp. 758,762, 3-7 Dec. 2012 (doi: 10.1109/GLOCOMW.2012.6477670), incorporated herein in its entirety.

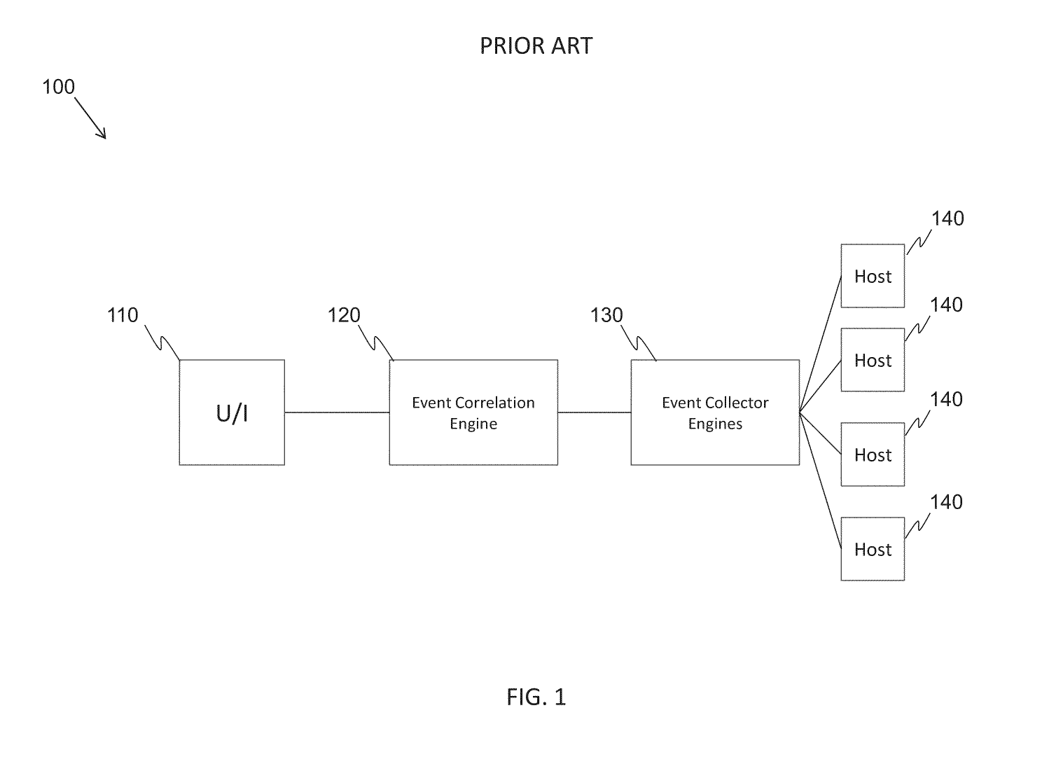

FIG. 1 illustrates a prior art CND system 100, or architecture, including a user interface 110, an event correlation engine 120, event collector engines 130 and hosts 140. The user interface 110 provides a graphical view of the system status to a network operator, and may additionally be used to specify policies, e.g. authentication, access control, etc., for the individual hosts 140 and applications in the network. The event correlation engine 120 may execute a real-time response that may quarantine parts of the network affected by a security event, or attack. The correlation engine 120 may employ one or more of: a meta-language to specify and capture events; data fusion capability to describe overall behavior of the attack based on discrete events received by the correlation engine 120; and a semi-automatic response to thwart attacks before they infect the entire network. The event collector engines 130 may be software agents co-located with the hosts 140, e.g. computing devices in communication with the CND system 100, or may be applications running on the hosts 140. When an agent detects behavior that is contrary to the normal operation of the host or application, it may inform the event collector engines 130. Each of the event collector engines 130 is typically tuned to a particular application. For instance, an agent for a web server may monitor an event log file associated with software implementing the server, and inform the corresponding correlation engine 120 of abnormal behavior, e.g. frequent requests to access resources coming from a same IP address, or an attempt to access a resource known to be vulnerable.

Because the information from the collector engines 130 in sent unfiltered to the event correlation engine 120, the system 100 may be vulnerable to alert overload and high false alarm rate. Indeed, a malicious entity could exploit these vulnerabilities to render the system 100 unable to effectively guard against attack.

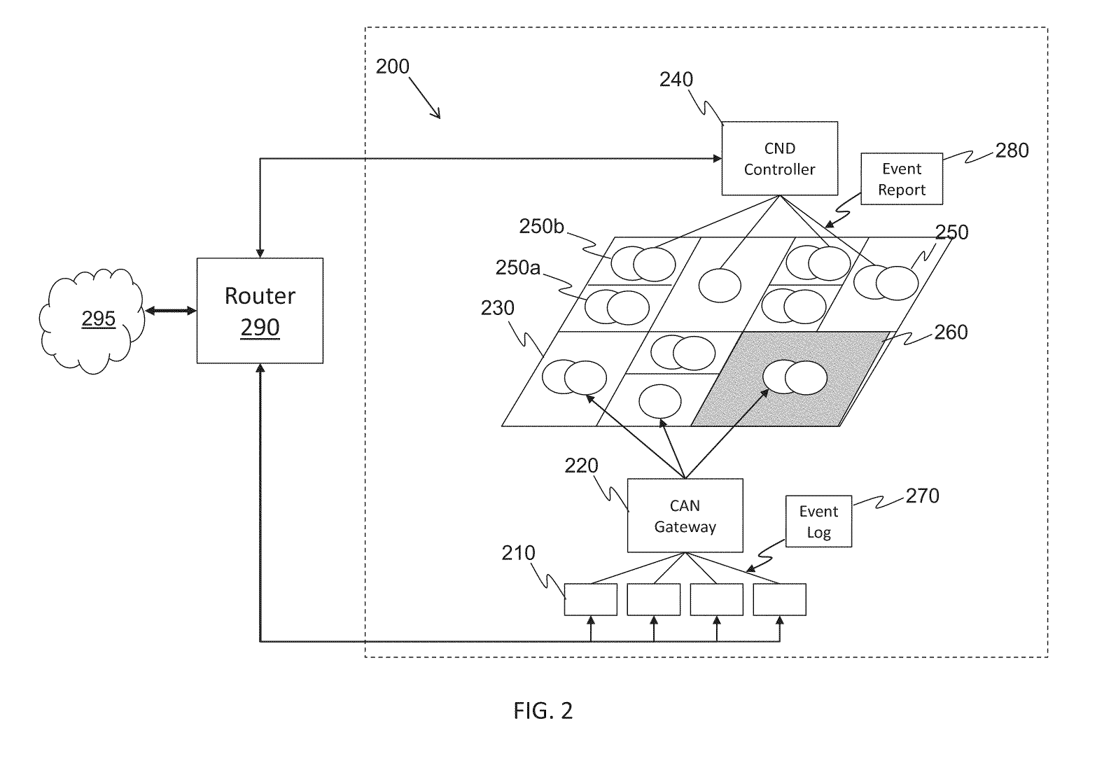

FIG. 2 illustrates a network 200, illustrative of various embodiments, configured to address some of the deficiencies of prior art networks, e.g. the system 100 (FIG. 1) to provide improved processing of security events. The network 200 includes event generators 210, a CAN gateway 220, a distributed hash table (DHT) 230, and a central CND controller 240. As appreciated by those skilled in the art, a DHT is a class of a decentralized distributed system, or data structure, that provides a lookup service similar to a hash table. Key/value pairs are stored by nodes of the DHT, and any participating node can efficiently retrieve the value associated with a given key. The operation of mapping a value to a given key is referred to herein as the hash function of the DHT 230. Responsibility for maintaining the mapping from keys to values is distributed among the nodes, in such a way that a change in the set of participants causes a minimal amount of disruption. This allows a DHT 230 to scale to extremely large numbers of nodes and to handle continual node arrivals, departures, and failures. The role of the hash function is described further below.

The event generators 210 may be or include, e.g. host computers, applications executing on hosts, routers, or other network elements. The event generators 210 produce security events. As used herein, the term “security event” refers to the occurrence of a particular event or pattern of events consistent with a possible attack on one or more members of the network 200. Such attacks may occur via communication by the attacker with an event generator 210 using one of several available communications protocols. Such protocols include, e.g. hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS. Those skilled in the pertinent art will appreciate that the listed protocols are a subset of available protocols, and the principles of the disclosure may be applied to any of the larger set of protocols. In two nonlimiting examples, an attacker may employ an enumeration attack or a denial of service (DOS) attack. These examples are described in greater detail below.

Security events may occur in discrete applications and/or agents executed on the event generators 210. These software entities may provide a detailed account of an attack, e.g. an event log 270 (or simply log) of communications events, also referred to as alerts. The event log 270 may include, e.g., a record of the type of communication protocol received from a particular attacker (e.g. identified by an internet protocol address of the attacker), and a timestamp of the communication.

The gateway 220 receives the logged security events from the event generators 210 and, as described further below, distributes the events to peers (or nodes) 250 of the DHT 230. Each peer 250 may be a computer, e.g. a server, that is configured to communicate with each of the other peers 250 in the network DHT 230, with the CAN gateway 220 and the controller 240.

Each peer 250 maintains a portion of the DHT 230 under its control. Because no one peer 250 is responsible for the entire DHT 230, important properties such as resilience, scalability, and fault tolerance can be provided. Compared to the linear complexity (O(N)) of finding a datum among N peers in an unstructured approach, a DHT may provide the ability to locate an item with a complexity of O (log N) equal to the complexity of well-known non-distributed search and indexing techniques. Necessary DHT maintenance operations like routing performance, peers joining and departing the DHT, and routing state maintenance each have a complexity of O (log N). The DHT may be organized under one of several available algorithms. For example, ring-based approaches such as Pastry, Tapestry and Chord, which each use similar search algorithms such as binary ordered B*trees. Content Addressable Networks (CAN) and Viceroy may use a geometric design, e.g. an n-dimensional torus, such that a peer 250 is assigned a portion of a search space [0, 2n−1] often referred to as a zone.

In some embodiments the gateway 220 accepts logs 270 only from event generators 210 that are authenticated. This authentication is expected to improve security of the network 200 by making it difficult for an attacker to mimic an event generator. Appropriate authentication procedures are well known to those skilled in the pertinent art, and may include, e.g. public-private key cryptography, in which one of the event generators 210 and the gateway 220 use their identities in a security certificate to perform mutual authentication, and a public key to encrypt the channel over which this information is transmitted.

There are two related aspects that may be addressed to maintain a level of security of the CND. First, the peer 250 associated with each of the zones in the DHT 230 may be authenticated. Lack of authentication may allow an entity to inject itself into the DHT 230 as a malicious peer. Second, the gateway 220 may reject event logs 270 of event generators 210 whose identity has not been well established. This exclusion may prevent unknown and possibly malicious hosts, routers, or applications to inject spurious or erroneous events into the CND. These security measures may be implemented by one of the peers 250 operating as a bootstrap node, and the gateway 220.

The first peer 250 to join the DHT 230 may be referred to as the bootstrap node. One of the peers 250 may be assigned as the bootstrap node when the network 200 is implemented. Each of the other peers 250 acquires the network address of the bootstrap node on startup. The peers 250 contact the bootstrap node, which admits the joining peers 250 nodes into the CAN by either splitting its own zone 260 or by redirecting the joining peer 250 to a neighboring peer 250. If the neighboring peer 250 is not the destination node, the neighboring peer 250 may redirect the joining peer 250 until the destination zone 260 is reached. The peer 250 associated with the destination zone 260 may then proceed to split its zone 260 with the joining peer 250 taking over responsibility of one portion of the split zone 260 as determined by the CAN protocol. In various embodiments all nodes in the DHT 230, including the bootstrap node and the peers 250, have certificates issued by a local or global certificate authority. In other embodiments the certificates are self-signed. However, this latter embodiment may require that the bootstrap node be provided a fingerprint related to the certificate of the joining peer 250.

In some embodiments the system 200 is configured such that the only configuration required is for the event generators to know the network coordinates of the gateway 220 so they can transmit event logs to the gateway 220. Such a configuration substantially automates the configuration of the network 200, thereby avoiding mis-configuration that can lead to suboptimal performance of the component parts of the network 200.

In some embodiments each event generator 210 may possess a certificate that asserts its identity for authentication and derivation of cryptographic keys related to encryption. The certificate may be, e.g. issued by an enterprise IT domain, global certificate authority, or may be a self-signed certificate with fingerprint validation. When the event generators 210 transmit security events to the CAN gateway 220, the gateway 220 may verify the identity of the sending event generators 210 before percolating the event into the DHT 230. When a particular event generator 210 is successfully authenticated, the alert information from that event generator 210 may flow between that generator 210 and the gateway node 220 confidentially by deriving appropriate an encryption key from the certificate. The peers 250 may be seeded with the network location of the gateway node 220 a priori.

The controller 240 is configured to receive from each of a plurality of the peers 250 a security event report 280. Each of the reports 280 may be associated with a particular communication protocol, e.g. as reported in the event logs 270. After receiving the event reports 280 from the peers 250, the controller 240 may correlate the reports to determine the nature of a possible attack, and may defend the network against such an attack. In some embodiments the defense includes making a notification available that may be perceived by a network administrator. For example, a suitable notification may be visual or aural, and may be displayed on a screen available to the administrator. In other embodiments the defense includes sending instructions to a router 290 that is configured to control traffic flow between the network 200 and the internet 295. The router 290 and the controller 240 may be connected by a physical data path, e.g. an electrical or optical path. For the purposes of this discussion a wireless electrical (e.g. radio frequency) signal is defined as an electrical physical data path. The instructions may, for example, direct the router 290 to block all IP packets originating from an IP address associated with the threat.

In various embodiments a network administrator may configure the controller 240 to implement a strategy to defend the network 200. Such a strategy may include a prioritization of attacks to defend against. The interaction between the administrator and the attacker can be modeled using game theory. Such a game may include zero-sum or general-sum, pure or mixed strategies, with simultaneous or sequential information, and perfect or imperfect information.

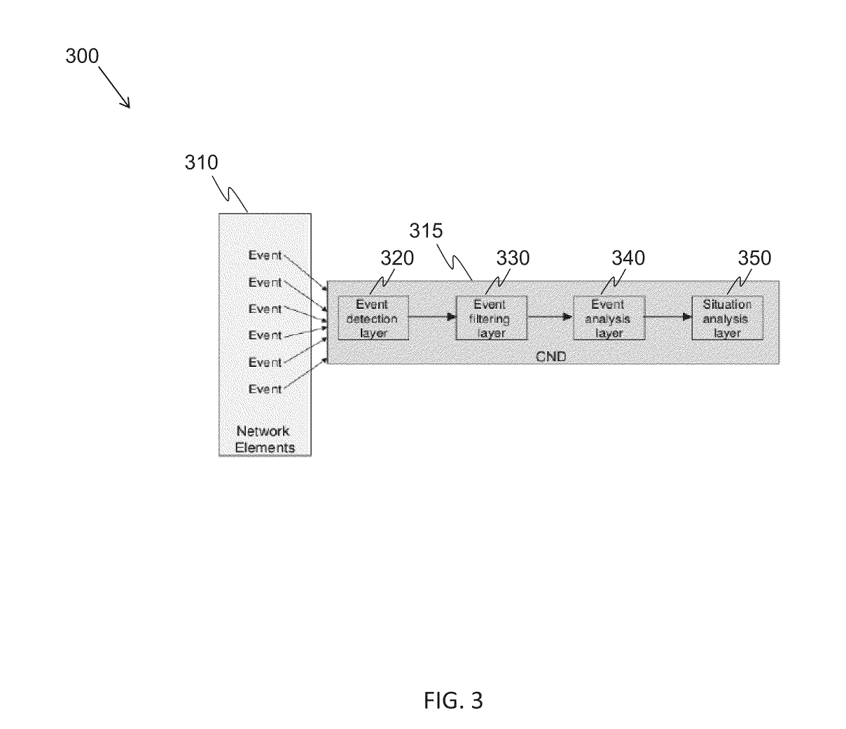

FIG. 3 illustrates schematically a logical operational model 300 of the network 200 presented to aid understanding of the operation of the described embodiments. Events are produced at network elements 310, e.g. the event generators 210. A CND 315 is represented by a number of logical layers, in which an event detection layer 320 receives the events. An event filter layer 330 receives the detected events from the event detection layer 320, and filters the events to reduce the information flow to downstream layers. An event analysis layer 340 receives filtered event data from the event filtering layer 330 and determines whether a security threat is present. A situation analysis layer 350 receives the analysis output by the event analysis layer 340 and determines a response to the detected threat. These aspects of the analysis layers 340 and 350 are beyond the scope of the present disclosure. The layers 320-350 may be implemented by, e.g. the event generators 210, the peers 250 and the CAN controller 240.

One example of an attack is referred to as an enumeration attack. The following example is presented without limitation. Those skilled in the pertinent art will appreciate that the disclosed principles may be extended to other types of attacks without undue experimentation. This attack may begin with a malicious entity guessing usernames and sending username requests to network servers. If the usernames are valid within the domain of the servers, some servers respond with a 401 SIP response code asking the attacker to provide a response to an HTTP Digest challenge. If the usernames are not valid within the domain of the server, some servers simply return a 403 SIP response code. Thus, the attacker may differentiate between the two responses, e.g. a 401 versus a 403, to determine whether a certain user account exists on the SIP server or not. Armed with a set of such accounts, the attacker can try to perform a brute-force attack by providing a dictionary-based response to the challenge issued in a 401 SIP response.

Returning to FIG. 2, to protect against an enumeration attack, the event generators 210 may monitor log files of SIP proxies or user agents, and may extract certain information using the canonical format of the log record. In various embodiments the event generators 210 may extract one or more of the communication protocol used (e.g. SIP/2.0), the network information of the sender of the request (e.g. IP, port, transport), the username in the request, the response sent by the SIP server, timestamps, and other identifiers may be extracted from the log files. These data may be assembled into the event log 270, e.g. an event protocol data unit (PDU), and sent to the gateway 220. Noting that in some embodiments the event generators are authenticated to the gateway 220, the event log 270 may be transported securely from the event generator 210 to the gateway 220. When the gateway 220 receives the event log 270, it may extract the protocol from the event log 270, e.g. SIP/2.0 in the specific nonlimiting example of an enumeration attack, and may use the extracted protocol as input to the hash function to find the coordinates of the CAN zone 260 assigned to process SIP events. Once the gateway 220 has determined the correct zone, it may send the remaining information conveyed by the event log 270 to the responsible peer 250, e.g. using a DHT put( ) primitive.

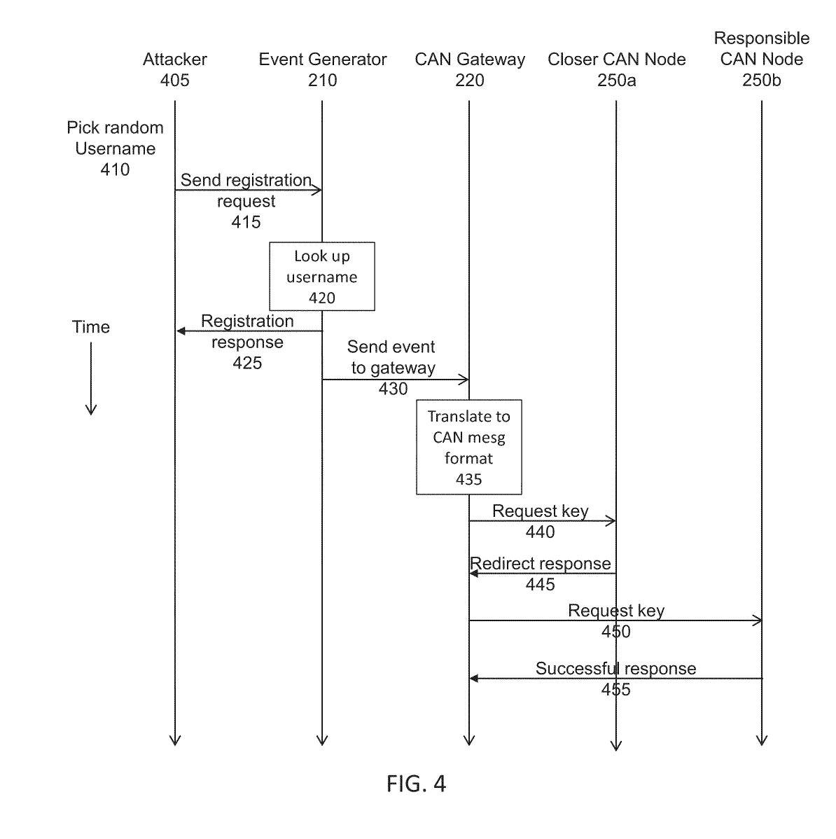

FIG. 4 illustrates operation of the network 200 in one embodiment, beginning with a security event arriving at the gateway 220. The illustrated embodiment assumes that an attacker 405 is executing an enumeration attack using the SIP protocol. In a step 410 the attacker provides a username, which may be randomly generated, acquired from a web site security breach, etc. In the following discussion it is assumed that the username is not a recognized username of the network 200. In a step 415 the attacker 405 sends a registration request to one event generator 210. The event generator 210 may, in accordance with normal operation, look up the username in a step 420, and provide a registration response 425 (e.g. unsuccessful registration) to the attacker 405. The event generator 210 logs the failed registration attempt, and in a step 430 sends an event log (alert), e.g. the event log 270, to the CAN gateway 220. The event log includes a protocol tag indicating the communications protocol associated with the failed registration, e.g. SIP.

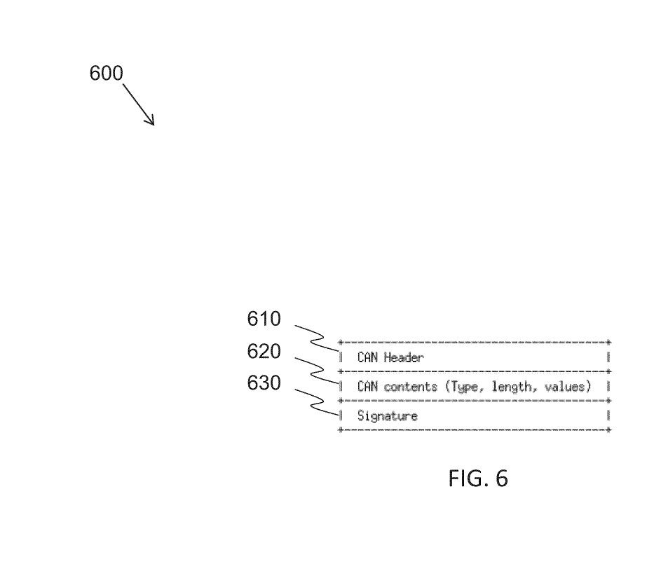

In a step 435 the gateway 220 translates the message conveying the event log 270 to a CAN message format. FIG. 6 illustrates a CAN message format that may be suitable for use in some embodiments. Those skilled in the pertinent art are familiar with basic aspects the CAN message format. In FIG. 6 a CAN message 600 includes a header 610, a contents field 620 and a signature 630. The event log 270 may be conveyed via the contents field 620 with suitable type, length and value parameters.

Referring again to FIG. 4, in a step 440 the gateway 220 then sends a key request to a peer (or CAN node) 250. By this request the gateway 220 seeks to determine the identity of the peer 250 responsible for the communication protocol associated with the security event. In the illustrated embodiment the gateway 220 sends the request to a first peer, e.g. the peer 250a, that may help route the message to the second peer 250b responsible for the SIP alerts. The peer 250a has been configured to aggregate events associated with a different communication protocol than SIP, e.g. HTTP, and therefore at a step 445 returns to the gateway 220 a redirect response that indicates the peer 250b as the peer responsible for SIP event correlation and aggregation (the “responsible” peer). In a step 450 the gateway 220 then sends to the peer 250b a second key request. This request may include a put( ) request that includes the alert. The peer 250b then returns, in a step 455, a response to the gateway 220 that indicates that the peer 250b is the responsible peer. The response may include an indication that the peer 250b has received the alert. The peer 250b can now associate the reported security event with earlier or later events and generate the report 280 as appropriate. This aspect is address in additional detail below.

Aggregation algorithms performed by the peers 250, e.g. the peer 250b, may summarize a plurality of discrete security events and/or alarms originating from different ones of the event generators 210 for a specific class or type of event. Correlation algorithms may take the aggregated information, as well as other available information, and determine a root cause of the events. The peers 250 may also perform statistical analysis of the events, e.g. determine a number of events per unit time, a histogram of event counts over a time range, or an average number of events in one or more time units. Embodiments are not limited to any particular aggregation, correlation and/or statistical algorithms, of which further treatment is beyond the scope of the disclosure. Moreover, the suitability of an algorithm or algorithms may depend on the specific threat environment.

In another nonlimiting example, a DOS attack based on parsing may proceed in a similar manner to that described by FIG. 4. In this situation one of the event generators 210 may be configured to operate as a SIP server. A parsing error may occur when a SIP server fails to receive a complete SIP message. In this event the event generator 210 may send a 400 SIP response code to the gateway 220, which forwards the code to the responsible peer 250. An excessive number of 400 SIP response codes arriving in a given time period at that peer 250 may be interpreted by the correlation algorithm to indicate a denial of service attack may be occurring. The peer 250 may provide to the controller 240 the report 280 indicating the nature of the attack for further defensive action.

Returning again to FIG. 2, the architecture of the DHT 230 is based on a virtual mathematical space. This space is represented for convenience in FIG. 2 as a plane, wherein the space is divided into CAN zones 260. Each zone 260 includes at least one peer 250. The peer(s) 250 in each zone are responsible for aggregation of the reported security events associated with a particular communication format. For example, the peer 250a may receive for aggregation security events associated with HTTP protocol communications received by the event generators 210, and the peer 250b may receive for aggregation security events associated with SIP protocol communications received by the event generators 210. In some cases multiple peers 250 may be grouped in a single zone 260. In such cases the two (or more) peers may operate redundantly, or may negotiate to determine which peer 250 will operate to aggregate security events and report to the controller 240.

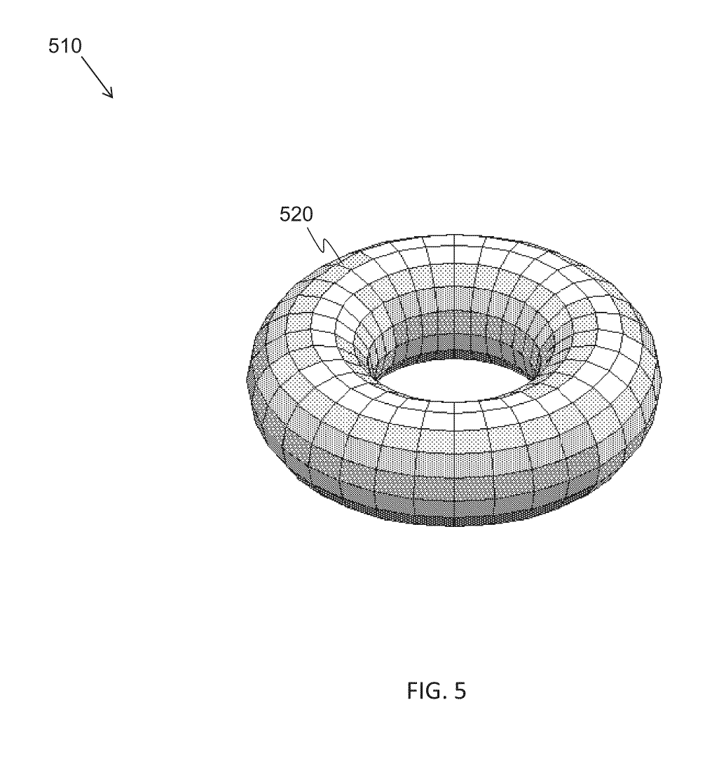

In some embodiments the DHT architecture is modeled as a toroidal surface. FIG. 5 illustrates a torus 510 that includes zones 520 on the surface. Each of the zones 520 may be a CAN zone, e.g. one of the zones 260. While the example shows zones having a same area, in a general case the zones 260 may be differently sized, and the zones 520 may be differently sized, and may be arbitrary in size and shape along the surface of the model space. The size of the zones 260 may be related to, e.g. the number of nodes and/or the CAN space partitioning algorithm. Those skilled in the pertinent art will appreciate that the toroidal model exemplified by FIG. 5 may be an appropriate mathematical tool in the context of content addressable networks, but embodiments are not limited to toroidal CAN models, and may be implemented with models that provide different performance than the toroidal model.

For discussion purposes the zones 520 may be viewed as mapped onto a two-dimensional (2D) Cartesian space, e.g. a plane, with extents determined by (x, y) coordinates. Thus, a zone 520 may be represented by a first corner at (x₁, y₁) and an opposite corner at (x₂, y₂). This zone space is referred to without limitation as CAN C. The peer 250 within CAN C may be equivalently referred to as peer C. In a nonlimiting example to illuminate the discussion below, a zone file may implement a zone mapping as follows:
Version xxxxxx
http (0,0)×(128,128)
sip (0,256)×(128,128)
phishing (128,0)×(256,128)

To provide secure communication between the peers 250, an arbitrary, e.g. random or pseudorandom, point P (x, y) within CAN C (x₁<x<x₂ and y₁<y<y₂) may be selected as a key. The key may be used by peer C to route a put( ) lookup( ) or get( ) request to the peer 250 responsible for the zone 260 that contains the point P. Each zone may be responsible for a specific intrusion related to a protocol; thus, one zone (e.g. the zone 260 occupied by the peer 250a) may be responsible for HTTP intrusions while another zone (e.g. the zone 260 occupied by the 250b) may be responsible for SIP intrusions, and so on. In some embodiments overloading of the peer 250 in a particular zone 260 may be allowed for reliability purposes. In some embodiments security and integrity of the DHT 230, put( ) get( ) and lookup( ) requests is provided by constraining these requests to pass through the gateway 220.

Thus, referring again to FIG. 2, the gateway 220 may act as an interface between the DHT 230 and the external users of the network, e.g., the event generators 210. The event generators 210 may send put( ) requests to the gateway 220, which in turn interfaces with the DHT 230 to store and retrieve user data. The peers 250 may perform put( ) and get( ) functionality without contacting the gateway 220. As discussed previously, in various embodiments the gateway 220 accepts put( ) requests only from event generators 210 that can be authenticated, e.g. using a certificate that encodes their identity and public key. In various embodiments the gateway 220 does not accept events from an event generator 210 it cannot authenticate appropriately. Advantageously, the gateway 220 is scalable, as the number of events arriving into the system can be large. Under heavy traffic, the gateway 220 may perform minimal processing of messages and may instead spawn additional worker gateway nodes to which the gateway 220 may direct the incoming traffic. An additional benefit of this decomposition is that the gateway 220 may allow the collection of data such as a number of redirects that occur when inserting or retrieving data from the DHT 230. These data may be used to describe the statistical behavior of the CAN (e.g., computing the average path length, average delay, etc.).

The gateway 220 may determine the protocol associated with the logged events which it is receiving events for receives an event log (e.g. an alert) it knows. The gateway 220 may then use a hash function that takes as input an invariant for that event generator 210, e.g. an IP address, a unique key assigned to that event generator 210, or a universally unique identifier computed once at startup. The gateway 220 may then produce a point P in C that is bounded by the space of the zone 260 responsible for collecting the specific alert generated by the event generator 210. In some embodiments the gateway node 210 does not compute P for each alert, but instead computes and caches P once on startup. The gateway 210 then need only re-compute P if the topology of C changes, such as by the addition of a new zone 260, and the resulting resizing of the remaining zones 260.

Those skilled in the pertinent art will appreciate that computational entities in the described embodiments may be implemented by a processor and a memory coupled to the processor. The memory includes instructions that when executed by the processor configure the processor to operate to implement aspects of the described embodiments. Thus, the event generators 210, the gateway 220, the peers 250 and the controller 240 may each be implemented by a processor and a memory. The instructions stored in the memory may be provided by a nontransitory computer-readable storage medium, e.g. a magnetic or optical disk, or a flash drive. The instructions may alternatively or also be delivered via a network connection to a software provider.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An apparatus, comprising:
a processor;
a memory coupled to said processor and containing instructions that when executed configure the processor to:
receive from a host a security event log including a protocol tag; and
securely forward the security event log, to a selected one of a plurality of peers in a distributed hash table (DHT), based on the protocol tag.

2. The apparatus of claim 1, wherein said DHT is a content addressable network (CAN).

3. The apparatus of claim 1, wherein said processor is configured to accept said security event log only on the condition that the security event log includes a valid security certificate.

4. The apparatus of claim 1, wherein said processor is configured to forward said security event log only on the condition that said selected one is authenticated.

5. The apparatus of claim 1, wherein said protocol tag is selected from the group consisting of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.

6. An apparatus, comprising:
a processor;
a memory coupled to said processor and containing instructions that when executed by the processor configure the processor to:
receive one of a plurality of security event reports from corresponding ones of a plurality of peers in a computer network, each one of the security event reports being associated with a particular communication protocol; and
defend, in response to the received security event reports, against a threat to the network based on the received security event reports.

7. The apparatus of claim 6, wherein said peers are members of a distributed hash table (DHT).

8. The apparatus of claim 7, wherein said DHT includes a content addressable network (CAN).

9. The apparatus of claim 6, wherein said processor is configured to accept the security event reports only on the condition that identities of each of the peers are authenticated.

10. The apparatus of claim 6, wherein said processor is configured to block traffic from an IP address associated with said threat.

11. The apparatus of claim 6, wherein said communication protocol is selected from the group consisting of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.

12. An apparatus, comprising:
a processor;
a memory coupled to said processor and containing instructions that when executed configure the processor to:
receive security events from an event generator;
filter said events based on an assigned communication protocol;
produce a security report from said filtered events; and
send said report to a security controller.

13. The apparatus of claim 12, wherein said processor is further configured to filter events by rejecting events associated with non-assigned communication protocols.

14. The apparatus of claim 12, wherein the processor is configured to receive said events from a single gateway computer.

15. The apparatus of claim 12, wherein said assigned communication protocol is selected from the group consisting of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.

16. The apparatus of claim 12, wherein said processor is one of a plurality of processors configured to filter said events based on said assigned communication protocol, but only said processor is configured to send said report to a security controller.

17. An method, comprising:
receiving from a host a security event log including a protocol tag; and
securely forwarding the security event log, to a selected one of a plurality of peers in a distributed hash table (DHT), based on the protocol tag.

18. The method of claim 17, wherein said DHT is a content addressable network (CAN).

19. The method of claim 17, further comprising accepting said security event log only on the condition that the security event log includes a valid security certificate.

20. The method of claim 17, further comprising forwarding said security event log only on the condition that said selected one is authenticated.

21. The method of claim 17, wherein said protocol tag is selected from the group consisting of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.

22. An method, comprising:
receiving one of a plurality of security event reports from corresponding ones of a plurality of peers in a computer network, each one of the security event reports being associated with a particular communication protocol; and
defending, in response to the received security event reports, against a threat to the network based on the received security event reports, the defending comprising at least one of 1) electronically generating an visual or aural notification, and 2) directing instructions to a router via a physical data path to block internet traffic originating from an IP address associated with the threat.

23. The method of claim 22, wherein said peers are members of a distributed hash table (DHT).

24. The method of claim 23, wherein said DHT includes a content addressable network (CAN).

25. The method of claim 22, further comprising accepting said security event reports only from ones of the peers that have an authenticated identity.

26. The method of claim 22, wherein said instructions direct said router to block IP packets from said IP address to a controller of the network.

27. The method of claim 22, wherein said communication protocol is selected from the group consisting of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.

28. An method, comprising:
receiving logs of security events from an event generator;
filtering said events based on an assigned communication protocol;
producing a security event report from said filtered events; and
sending said event report to a security controller.

29. The method of claim 28, further comprising filtering said events by rejecting events associated with non-assigned communication protocols.

30. The method of claim 28, wherein said filtering may include determining a statistical measure of the filtered events.

31. The method of claim 28, wherein said assigned communication protocol is selected from the group consisting of hypertext transfer protocol (HTTP), secure hypertext transfer protocol (HTTPs), session initiation protocol (SIP), secure shell protocol (SSH), file transfer protocol (FTP), and secure file transfer protocol (sFTP) and Microsoft NetBIOS.
